(19) United States
(12) Patent Application Publication
(10) Pub. No.: US 2008/0148334 A1
(43) Pub. Date: Jun. 19, 2008

(54) Techniques to enable a Wi-Fi access point to convert DTV broadcasting into Wi-Fi broadcasting

(76) Inventors: Yuval Finkelstein, Yokneam Elite (IL); IIan Sutskover, Hadera (IL)

Correspondence Address: INTEL CORPORATION;c/o INTELLEVATE, LLC, P.O. BOX 52050, MINNEAPOLIS, MN, 55402, US

(21) Appl. No.: 11/639,122

(22) Filed: Dec. 13, 2006

(51) Int. Cl. H04N 7/00

(52) U.S. Cl. 725/131

(57) ABSTRACT

An embodiment of the present invention provides an apparatus, comprising an access point (AP) including a digital television (DTV) receiver.

### BACKGROUND

Digital television (DTV) is an emerging market today. Deployment of terrestrial broadcasting began during 2005 and the market is currently moving toward handheld-oriented broadcast services that can withstand mobility of the receivers. DVB-H and T-DMB are going to be widely deployed for mobile TV, whereas DVB-T is already widely deployed for nomadic-to-portable reception conditions.

Currently, a Wi-Fi client is not able to receive DTV signals unless it has special hardware and software components. Wi-Fi is another name for the Institute for Electronic and Electrical Engineers (IEEE) 802.11 standard and coined by the Wireless Ethernet Compatibility Alliance (WECA). Products certified as Wi-Fi by WECA are interoperable with each other even if they are from different manufacturers. A user with a Wi-Fi product can use any brand of Access Point with any other brand of client hardware that is built to the Wi-Fi standard. The term Wi-Fi and 802.11 may be used interchangeably herein.

As it would be advantageous to be able to receive DTV signals by a wireless client without the need for special hardware and software components, there is a strong need for techniques to enable a Wi-Fi access point to convert DTV broadcasting into Wi-Fi broadcasting.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates an apparatus and system of an embodiment of the present invention; and

FIG. 2 is a flowchart of the method of an embodiment of the present invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Embodiments of the invention may be used in a variety of applications. Some embodiments of the invention may be used in conjunction with various devices and systems, for example, a transmitter, a receiver, a transceiver, a transmitter-receiver, a wireless communication station, a wireless communication device, a wireless Access Point (AP), a modem, a wireless modem, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, a network, a wireless network, a Local Area Network (LAN), a Wireless LAN (WLAN), a Metropolitan Area Network (MAN), a Wireless MAN (WMAN), a Wide Area Network (WAN), a Wireless WAN (WWAN), devices and/or networks operating in accordance with existing IEEE 802.11, 802.11a, 802.11b, 802.11e, 802.11g, 802.11h, 802.11i, 802.11n, 802.16, 802.16d, 802.16e standards and/or future versions and/or derivatives and/or Long Term Evolution (LTE) of the above standards, a Personal Area Network (PAN), a Wireless PAN (WPAN), units and/or devices which are part of the above WLAN and/or PAN and/or WPAN networks, one way and/or two-way radio communication systems, cellular radio-telephone communication systems, a cellular telephone, a wireless telephone, a Personal Communication Systems (PCS) device, a PDA device which incorporates a wireless communication device, a Multiple Input Multiple Output (MIMO) transceiver or device, a Single Input Multiple Output (SIMO) transceiver or device, a Multiple Input Single Output (MISO) transceiver or device, a Multi Receiver Chain (MRC) transceiver or device, a transceiver or device having “smart antenna” technology or multiple antenna technology, or the like. Some embodiments of the invention may be used in conjunction with one or more types of wireless communication signals and/or systems, for example, Radio Frequency (RF), Infra Red (IR), Frequency-Division Multiplexing (FDM), Orthogonal FDM (OFDM), Time-Division Multiplexing (TDM), Time-Division -Multiple Access (TDMA), Extended TDMA (E-TDMA), General Packet Radio Service (GPRS), Extended GPRS, Code-Division Multiple Access (CDMA), Wideband CDMA (WCDMA), CDMA 2000, Multi-Carrier Modulation (MDM), Discrete Multi-Tone (DMT), Bluetooth (RTM), ZigBee (TM), or the like. Embodiments of the invention may be used in various other apparatuses, devices, systems and/or networks.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. For example, “a plurality of stations” may include two or more stations.

An embodiment of the present invention provides an improved access point (iAP) that converts one broadcast signal to another with both signals using different communication technology (i.e., it is not a simple relay that belongs to the same network operator). In particular, in an embodiment of the present invention, the combination of digital TV (DTV) and Wi-Fi is set forth herein.

Two emerging technologies, Digital TV (DTV) broadcasting and WiFi transmissions, may be combined into a single device for the favor of the Wi-Fi client. Some embodiments of the present invention provide a device that may be a Wi-Fi Access-Point (AP), although the present invention is not limited in this respect. Traditionally an AP only provides wireless connection between the local distribution system and the stations in its Basic Service Set (BSS). An embodiment of the present invention provides equipping the AP with a DTV receiver (for example, but not limited to, for DVB-T, DVB-H and T-DMB), thus creating an improved AP (iAP). The iAP will be capable of receiving also these type of wireless signals. The present invention may encapsulate the TV data stream from the output of the DTV receiver, in a standard 802.11 frames, for example, but not limited to 802.11 frames. These frames will be broadcasted over the BSS following the broadcasting procedure in the 802.11 standard. Thus, the Wi-Fi stations in the BSS will be able to receive the contents of DTV signals without being equipped with any DVB receiver. Due to the capability of High-Throughput Wi-Fi devices to send and receive data at a rate that is as high as hundreds of Mbps, the broadcasting of TV contents over the wireless medium will not consume a significant portion of the available bandwidth (typically, useful bit-rate of DTV is around 2 Mbps to 20 Mbps). It is understood that the present invention is not only limited to High-Throughput devices.

Moreover, advanced DTV standards such as DVB-H and T-DMB provide the compressed video over IP packets. These IP packets can easily be extracted by the iAP and be broadcasted (as IP packets) to the iAP WiFi-capable clients.

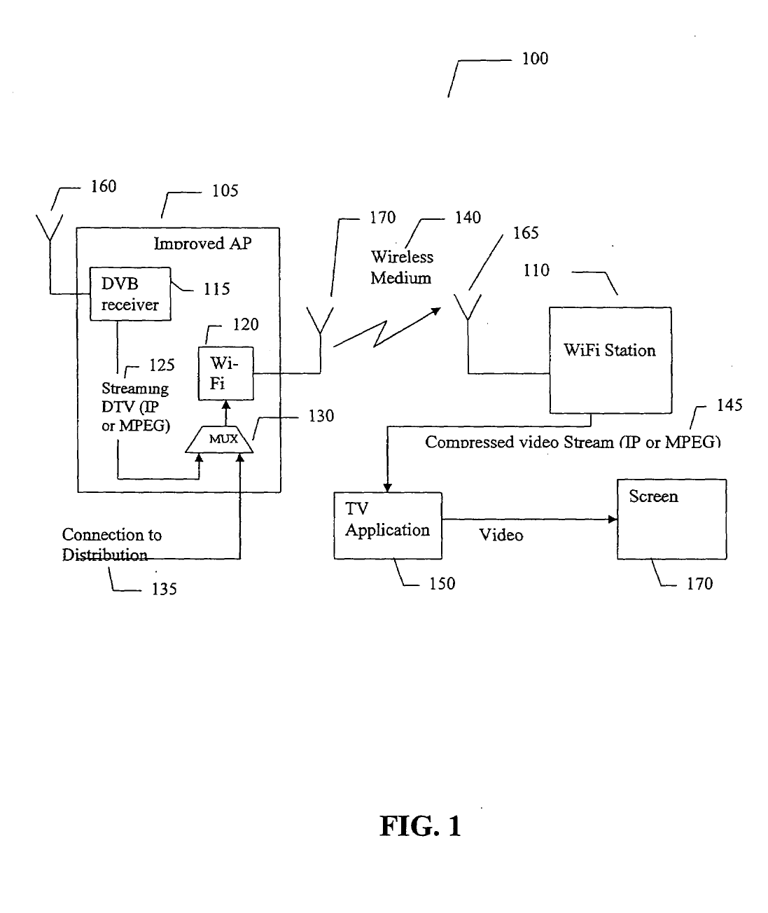

Turning now to the figures, FIG. 1, shown generally as 100, provides an apparatus and system according to some embodiments of the present invention. Improved Access Point (iAP) 105 may include DVB receiver 115 and Access point 120, wherein DVB receiver 115 streams digital television 125 to access point 120 via multiplexer 130. Connected to DVB receiver 115 may be antenna 160 and connected to access point 120 may be antenna 170. Further, access point 120 may be connected to distribution system 135 via multiplexer 130. Improved access point 105 may stream DTV via wireless medium 140 to wireless station 110 through antenna 165. The compressed video stream 145 received by the wireless client 110 may be provided to TV application 150 and played on screen 170.

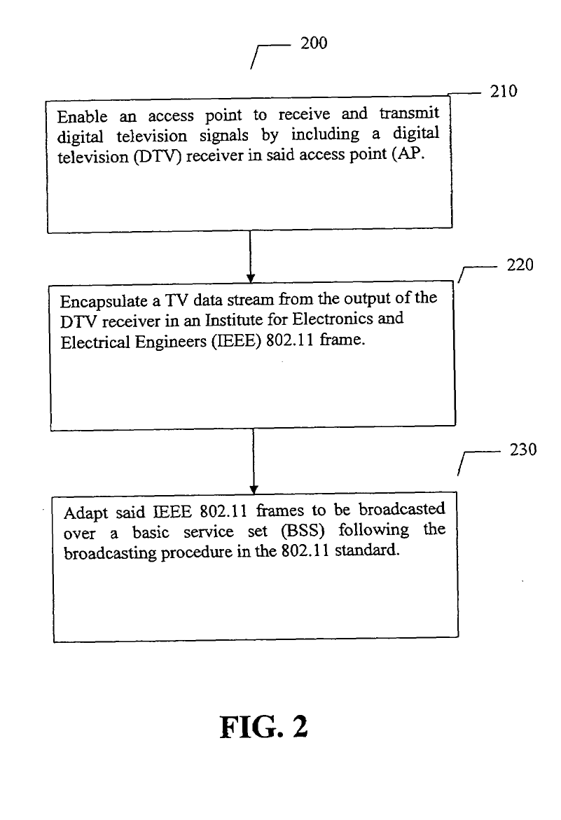

Yet another embodiment of the present invention is provided in FIG. 2, generally at 200, which provides a method according to some embodiments of the present invention. The present method may comprise enabling an access point to receive and transmit digital television signals by including a digital television (DTV) receiver in the access point (AP) 210. The method may further comprise encapsulating a TV data stream from the output of the DTV receiver in an Institute for Electronics and Electrical Engineers (IEEE) 802.11 frame 220; and still further comprise adapting the IEEE 802.11 frames to be broadcasted over a basic service set (BSS) following the broadcasting procedure in the 802.11 standard 230. An embodiment of the present invention also may further comprise adapting the encapsulated TV data stream transmitted by the AP to enable the data stream to be received by a wireless client associated with the AP and be displayed on a screen connected to the wireless client. The encoding of the TV data stream may be according to an MPEG or Internet Protocol format.

Some embodiments of the present invention may be implemented, for example, using a machine-readable medium or article which may store an instruction or a set of instructions that, if executed by a machine, for example, by the system of FIG. 1, by the iAP in connection with a processor (not shown), or by other suitable machines, cause the machine to perform a method and/or operations in accordance with embodiments of the invention. Such machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy. disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like.

In an embodiment of the present invention the machine-accessible medium that provides instructions, which when accessed, may cause the machine to perform operations comprising enabling an access point to receive and transmit digital television signals by including a digital television (DTV) receiver in the access point (AP). The machine-accessible medium may further comprise the instructions causing the machine to perform operations further comprising encapsulating a TV data stream from the output of the DTV receiver in an Institute for Electronics and Electrical Engineers (IEEE) 802.11 frame. Further, the machine-accessible medium may further comprise the instructions causing the machine to perform operations further comprising adapting the IEEE 802.11 frames to be broadcasted over a basic service set (BSS) following the broadcasting procedure in the 802.11 standard.

Some embodiments of the present invention may be implemented by software, by hardware, or by any combination of software and/or hardware as may be suitable for specific applications or in accordance with specific design requirements. Embodiments of the invention may include units and/or sub-units, which may be separate of each other or combined together, in whole or in part, and may be implemented using specific, multi-purpose or general processors or controllers, or devices as are known in the art. Some embodiments of the invention may include buffers, registers, stacks, storage units and/or memory units, for temporary or long-term storage of data or in order to facilitate the operation of a specific embodiment.

Yet another embodiment of the present invention provides a system, comprising an access point (AP), a wireless station in communication with the AP, and wherein the AP includes a digital television (DTV) receiver.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

We Claim:

1. An apparatus, comprising:
an access point (AP) including a digital television (DTV) receiver.

2. The apparatus of claim 1, wherein said AP encapsulates a TV data stream from the output of said DTV receiver in an Institute for Electronics and Electrical Engineers (IEEE) 802.11 frame.

3. The apparatus of claim 2, wherein said IEEE 802.11 frames are adapted to be broadcasted over a basic service set (BSS) following the broadcasting procedure in the 802.11 standard.

4. The apparatus of claim 3, wherein said encapsulated TV data stream transmitted by said AP is adapted to be received by a wireless client associated with said AP and be displayed on a screen connected to said wireless client.

5. The apparatus of claim 3, wherein said TV data stream is encoded according to an MPEG or Internet Protocol.

6. A method, comprising:
enabling an access point to receive and transmit digital television signals by including a digital television (DTV) receiver in said access point (AP).

7. The method of claim 6, further comprising encapsulating a TV data stream from the output of said DTV receiver in an Institute for Electronics and Electrical Engineers (IEEE) 802.11 frame.

8. The method of claim 7, further comprising adapting said IEEE 802.11 frames to be broadcasted over a basic service set (BSS) following the broadcasting procedure in the 802.11 standard.

9. The method of claim 8, further comprising adapting said encapsulated TV data stream transmitted by said AP to enable said data stream to be received by a wireless client associated with said AP and be displayed on a screen connected to said wireless client.

10. The method of claim 8, further comprising encoding said TV data stream according to an MPEG or Internet Protocol format.

11. A machine-accessible medium that provides instructions, which when accessed, cause a machine to perform operations comprising:
enabling an access point to receive and transmit digital television signals by including a digital television (DTV) receiver in said access point (AP.

12. The machine-accessible medium of claim 11, further comprising said instructions causing said machine to perform operations further comprising encapsulating a TV data stream from the output of said DTV receiver in an Institute for Electronics and Electrical Engineers (IEEE) 802.11 frame.

13. The machine-accessible medium of claim 12, further comprising said instructions causing said machine to perform operations further comprising adapting said IEEE 802.11 frames to be broadcasted over a basic service set (BSS) following the broadcasting procedure in the 802.11 standard.

14. The machine-accessible medium of claim 13, further comprising said instructions causing said machine to perform operations further comprising adapting said encapsulated TV data stream transmitted by said AP to enable said data stream to be received by a wireless client associated with said AP and be displayed on a screen connected to said wireless client.

15. The machine-accessible medium of claim 14, further comprising said instructions causing said machine to perform operations further comprising, encoding said TV data stream according to an MPEG or Internet Protocol format.

16. A system, comprising:
an access point (AP);
a wireless station in communication with said AP; and
wherein said AP includes a digital television (DTV) receiver.

17. The system of claim 16, wherein said AP encapsulates a TV data stream from the output of said DTV receiver in an Institute for Electronics and Electrical Engineers (IEEE) 802.11 frame.

18. The apparatus of claim 17, wherein said IEEE 802.11 frames are adapted to be broadcasted over a basic service set (BSS) following the broadcasting procedure in the 802.11 standard.

19. An apparatus, comprising:
a wi-fi access point; and
a DTV receiver streaming DTV signals via a multiplexer to said said wi-fi access point.

20. The apparatus of claim 19, further comprising a first antenna connected to said wi-fi access point and a second antenna connected to said DTV receiver.

21. The apparatus of claim 19, wherein said wi-fi access point is adapted to wirelessly communicate a compressed video stream to a wireless station.

22. The apparatus of claim 21, wherein said compressed video stream is in an MPEG or IP format.
